(19) United States
(12) Patent Application Publication
(10) Pub. No.: US 2025/0087413 A1
(43) Pub. Date: Mar. 13, 2025

(54) INDUCTOR COMPONENT

(71) Applicant: Murata Manufacturing Co., Ltd., Kyoto-fu (JP)

(72) Inventor: Yuuki KAWAKAMI, Nagaokakyo-shi (JP)

(73) Assignee: Murata Manufacturing Co., Ltd., Kyoto-fu (JP)

(21) Appl. No.: 18/818,226

(22) Filed: Aug. 28, 2024

(30) Foreign Application Priority Data
Sep. 12, 2023 (JP) 2023-147544

(51) Int. Cl. H01F 27/32; H01F 17/00

(52) U.S. Cl. CPC H01F 27/323; H01F 17/0013; H01F 2017/002

(57) ABSTRACT

An inductor component includes an element having a first main surface, a first interlayer insulator layer, an inter-wire insulator layer, and an inductor wire that extends in an area defined by the inter-wire insulator layer. The first interlayer insulator layer extends in the element to be parallel to the first main surface. The inter-wire insulator layer extends from the first interlayer insulator layer in a first positive direction orthogonal to the first main surface. In a cross section orthogonal to a center line of the inductor wire, portions of the inter-wire insulator layer are discontinuously arranged in a direction along the first main surface. One of the portions of the inter-wire insulator layer with a surface facing in the direction parallel to the first main surface being in contact with the element is an outer insulator layer in contact with an end surface of the first interlayer insulator layer.

### CROSS-REFERENCE TO RELATED APPLICATION

This application claims benefit of priority to Japanese Patent Application No. 2023-147544, filed Sep. 12, 2023, the entire content of which is incorporated herein by reference.

### BACKGROUND

### Technical Field

The present disclosure relates to an inductor component.

### Background Art

An inductor component described in Japanese Unexamined Patent Application Publication No. 2016-225463 includes an element, a substrate, resin walls, and a coil. The element is a rectangular prism. The element contains a magnetic material. The substrate has a plate shape. The substrate is located in the element. The resin walls are located on the main surface of the substrate. The resin walls extend in the direction normal to the main surface. In a cross-sectional view taken along the normal to the main surface of the substrate, the resin walls are arranged at intervals. In the cross-sectional view, the dimension of the resin walls in the direction in which the resin walls are arranged is defined as a thickness. In the cross-sectional view, the thickness of the resin walls located outermost in the direction in which the resin walls are arranged is greater than the thickness of the resin walls located on the inner side. The coil is located on the main surface of the substrate. The coil is filled in a space between adjacent resin walls.

### SUMMARY

As described in Japanese Unexamined Patent Application Publication No. 2016-225463, the thickness of the resin walls located outermost is greater, and thus the volume ratio of the resin walls occupied in the element is high. This structure does not easily allow an increase of the volume ratio of the coil occupied in the element.

Accordingly, the present disclosure provides an inductor component including an element having a main surface, an interlayer insulator layer extending in the element to be parallel to the main surface, an inter-wire insulator layer extending from the interlayer insulator layer in a first positive direction orthogonal to the main surface, and an inductor wire extending in an area defined by the inter-wire insulator layer while being in contact with a surface of the interlayer insulator layer facing in the first positive direction. In a specific cross section taken orthogonal to a center line of the inductor wire, a plurality of portions of the inter-wire insulator layer are discontinuously arranged in a direction along the main surface. Also, when one of outer surfaces of the interlayer insulator layer facing in a direction parallel to the main surface is defined as an end surface, and one of the plurality portions of the inter-wire insulator layer with a surface facing in the direction parallel to the main surface being in contact with the element is defined as an outer insulator layer, the outer insulator layer is in contact with the end surface of the interlayer insulator layer.

The above structure can increase an area in which the inductor wire can be disposed.

### BRIEF DESCRIPTION OF THE DRAWINGS

FIG. 1 is a perspective view of an inductor component;

FIG. 2 is a perspective side view of an inductor component;

FIG. 3 is a perspective top view of an inductor component;

FIG. 4 is a cross-sectional view of an inductor component taken along line 4-4 in FIG. 3;

FIG. 5 is an enlarged view of a portion in FIG. 4;

FIG. 6 is a diagram illustrating a method for manufacturing an inductor component;

FIG. 7 is a diagram illustrating a method for manufacturing an inductor component;

FIG. 8 is a diagram illustrating a method for manufacturing an inductor component;

FIG. 9 is a diagram illustrating a method for manufacturing an inductor component;

FIG. 10 is a diagram illustrating a method for manufacturing an inductor component;

FIG. 11 is a diagram illustrating a method for manufacturing an inductor component;

FIG. 12 is a diagram illustrating a method for manufacturing an inductor component;

FIG. 13 is a diagram illustrating a method for manufacturing an inductor component;

FIG. 14 is a diagram illustrating a method for manufacturing an inductor component;

FIG. 15 is a diagram illustrating a method for manufacturing an inductor component;

FIG. 16 is a diagram illustrating a method for manufacturing an inductor component;

FIG. 17 is a diagram illustrating a method for manufacturing an inductor component;

FIG. 18 is a diagram illustrating a method for manufacturing an inductor component;

FIG. 19 is a diagram illustrating a method for manufacturing an inductor component;

FIG. 20 is a diagram illustrating a method for manufacturing an inductor component;

FIG. 21 is a diagram illustrating a method for manufacturing an inductor component;

FIG. 22 is a diagram illustrating a method for manufacturing an inductor component; and

FIG. 23 is a cross-sectional view of an inductor component according to a modification example.

### DETAILED DESCRIPTION

An inductor component according to an embodiment is described below with reference to the drawings. In the drawings, components may be enlarged for ease of understanding. The dimensional ratios of components may be different from the actual ones or different between different drawings.

### Overall Structure

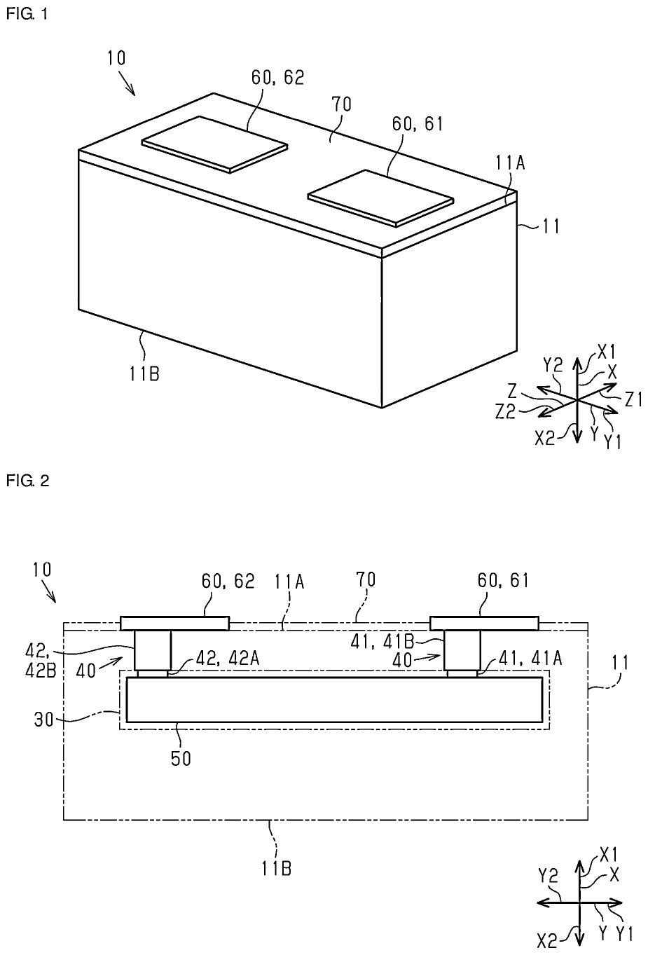

As illustrated in FIG. 1, an inductor component 10 has a substantially rectangular prism as a whole. As illustrated in FIG. 2, the inductor component 10 includes an element 11 and an inductor wire 50.

As illustrated in FIG. 1, the element 11 has six planar outer surfaces. A specific one of these six outer surfaces is defined as a first main surface 11A. The surface opposite to the first main surface 11A and parallel to the first main surface 11A is defined as a second main surface 11B. Each of the first main surface 11A and the second main surface 11B has a rectangular profile. In the present embodiment, the first main surface 11A is a surface facing a substrate when the inductor component 10 is mounted on the substrate.

The axis orthogonal to the first main surface 11A is defined as a first axis X. The axis orthogonal to the first axis X and parallel to a specific one side of the first main surface 11A, in the present embodiment, parallel to the long sides of the first main surface 11A is defined as a second axis Y. The axis orthogonal to the first axis X and the second axis Y is defined as a third axis Z. Of the direction along the first axis X, a direction in which the first main surface 11A faces is defined as a first positive direction X1, and the direction opposite to the first positive direction X1 is defined as a first negative direction X2. A specific one direction of the direction along the second axis Y is defined as a second positive direction Y1, and the direction opposite to the second positive direction Y1 is defined as a second negative direction Y2. A specific one direction of the direction along the third axis Z is defined as a third positive direction Z1, and the direction opposite to the third positive direction Z1 is defined as a third negative direction Z2.

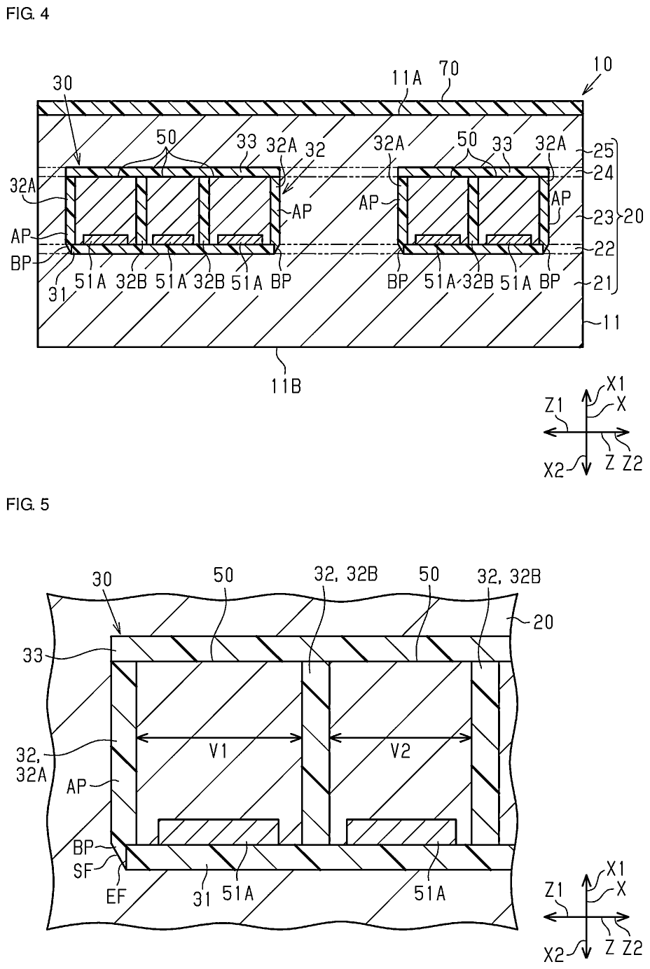

As illustrated in FIG. 4, the element 11 includes, as magnetic layers 20, in order from the first negative direction X2, a first magnetic layer 21, a first interlayer magnetic layer 22, a second magnetic layer 23, a second interlayer magnetic layer 24, and a third magnetic layer 25. FIG. 4 virtually illustrates boundaries between the magnetic layers 20 with two-dot chain lines, but no clear boundaries may be observable between these magnetic layers 20. The material of these magnetic layers 20 is an organic resin containing magnetic metal powder. More specifically, the element 11 contains a magnetic material. In the present embodiment, the magnetic metal powder is formed from a Fe-based alloy or an amorphous alloy. More specifically, the magnetic metal powder is FeSiCr-based metal powder containing iron. Instead of the FeSiCr-based metal powder, the magnetic metal powder may be, for example, FeCo-based metal powder, FeSiAr-based metal powder, iron-oxide-based metal powder, or a mixture of two or more of these. The organic resin may be epoxy, an imide, a liquid-crystal polymer resin, an acrylic resin, a phenol resin, or a mixture of two or more of these. In addition to the above materials, an inorganic filler may be mixed in the organic resin.

As illustrated in FIG. 2, the inductor wire 50 is located in the element 11. As illustrated in FIG. 4, the inductor wire 50 is located at the same position as the second magnetic layer 23 in the first positive direction X1. The materials of the inductor wire 50 are electroconductive materials. In the present embodiment, components of the inductor wire 50 include, for example, a copper ratio of greater than or equal to 99 wt % and a sulfur ratio of greater than or equal to 0.1 wt % and smaller than or equal to 1.0 wt % (i.e., from 0.1 wt % to 1.0 wt %). Instead of a conductor mainly composed of copper, the inductor wire 50 may be a conductor mainly composed of Ag, Al, or Au.

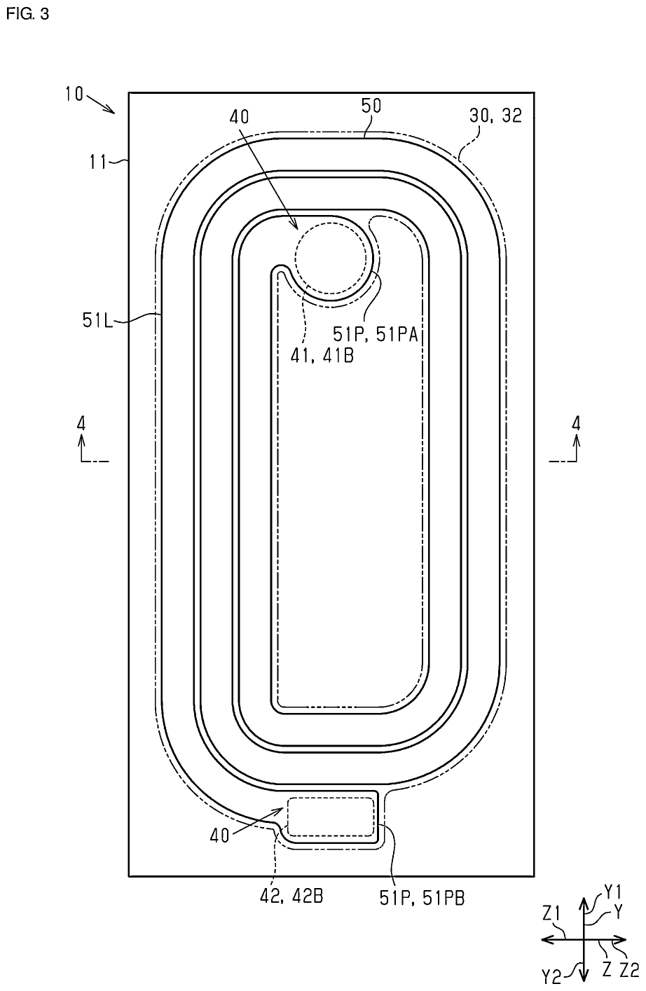

As illustrated in FIG. 3, the inductor wire 50 spirally extends parallel to the first main surface 11A. As illustrated in FIG. 4, the inductor wire 50 includes a seed layer 51A. The seed layer 51A forms a part of the surface of the inductor wire 50 facing in the first negative direction X2. The material of the seed layer 51A is copper. When the seed layer 51A undergoes electrolytic copper plating, copper grows on the seed layer 51A to form the entirety of the inductor wire 50.

As illustrated in FIG. 3, the inductor wire 50 includes a pair of pad portions 51P and a wire body 51L. The pair of pad portions 51P are located at both end portions of the inductor wire 50. One of the pair of pad portions 51P is defined as an inner pad portion 51PA. The other one of the pair of pad portions 51P is defined as an outer pad portion 51PB. When viewed in perspective in the first negative direction X2, the inner pad portion 51PA is located in the second positive direction Y1 with respect to the geometric center of the element 11. When viewed in perspective in the first negative direction X2, the inner pad portion 51PA is substantially circular. The outer pad portion 51PB is located in the second negative direction Y2 with respect to the geometric center of the element 11. When viewed in perspective in the first negative direction X2, the outer pad portion 51PB is substantially quadrangular.

The wire body 51L connects the pair of pad portions 51P. More specifically, when the element 11 is viewed in perspective in the first negative direction X2, the wire body 51L extends counterclockwise from the inner pad portion 51PA to the outer pad portion 51PB while increasing the diameter of each turn as the number of turns increases. The number of turns of the inductor wire 50 is 2.5 turns.

The number of turns of the inductor wire 50 is determined based on a virtual vector. The initial point of the virtual vector is disposed on the center line of the inductor wire 50. The inductor wire 50 makes 1.0 turn when the virtual vector rotates by an angle of 360 degrees while the initial point of the virtual vector is moved from the first end of the center line to the second end of the center line, when the virtual vector is viewed in the first negative direction X2. When the virtual vector rotates multiple times and rotates continuously in the same direction, the number of turns increases.

The center line of the inductor wire 50 is determined as follows. When viewed in perspective in the first negative direction X2, a shortest one of line segments drawable from any point on one edge of the inductor wire 50 to the opposite edge is specified. The line connecting the points passing the middle of the specified line segment is determined as the center line of the inductor wire 50 when viewed in perspective in the first negative direction X2.

As illustrated in FIG. 4, the inductor component 10 includes, as insulating layers 30, a first interlayer insulator layer 31, an inter-wire insulator layer 32, and a second interlayer insulator layer 33. The material of these insulating layers 30 is an insulating resin. In the present embodiment, the material is, for example, a polyimide-based resin.

As illustrated in FIG. 4, the first interlayer insulator layer 31 extends parallel to the first main surface 11A in the element 11. The first interlayer insulator layer 31 is in contact with the surface of the first magnetic layer 21 facing in the first positive direction X1. The first interlayer insulator layer 31 is in contact with the surface of the inductor wire 50 facing in the first negative direction X2. In other words, the inductor wire 50 extends over the first interlayer insulator layer 31. The first interlayer insulator layer 31 is thus located at the same position as the first interlayer magnetic layer 22 in the first positive direction X1.

The second interlayer insulator layer 33 extends parallel to the first main surface 11A in the element 11. The second interlayer insulator layer 33 is in contact with the surface of the inductor wire 50 facing in the first positive direction X1. The second interlayer insulator layer 33 is in contact with the surface of the third magnetic layer 25 facing in the first negative direction X2. The second interlayer insulator layer 33 is thus located at the same position as the second interlayer magnetic layer 24 in the first positive direction X1.

When the surfaces of the inductor wire 50 facing in a direction parallel to the first main surface 11A are defined as side surfaces, the inter-wire insulator layer 32 covers the side surfaces of the inductor wire 50. The inter-wire insulator layer 32 thus has a portion located at the same position as the inductor wire 50 in the first positive direction X1. In a specific cross section taken orthogonal to the center line of the inductor wire 50, a plurality of portions of the inter-wire insulator layer 32 are discontinuously arranged in a direction along the first main surface 11A. For example, in the specific cross section illustrated in FIG. 4, seven portions of the inter-wire insulator layer 32 are discontinuously arranged in a direction along the first main surface 11A.

In the specific cross section, at least one of the plurality of portions of the inter-wire insulator layer 32 with a surface facing in a direction parallel to the first main surface 11A being in contact with the element 11 is determined as an outer insulator layer 32A. In the specific cross section, at least one of the plurality of portions of the inter-wire insulator layer 32 with a surface facing in a direction parallel to the first main surface 11A being in no contact with the element 11 is determined as an inner insulator layer 32B. For example, the specific cross section illustrated in FIG. 4 has four outer insulator layers 32A. The specific cross section has three inner insulator layers 32B. More specifically, in the specific cross section, in the third positive direction Z1 with respect to the geometric center of the element 11, two outer insulator layers 32A are located and two inner insulator layers 32B are located between these outer insulator layers 32A. The inductor wire 50 is located between these portions of the inter-wire insulator layer 32. In addition, in the third negative direction Z2 with respect to the geometric center of the element 11, two outer insulator layers 32A are located and one inner insulator layer 32B is located between the outer insulator layers 32A. The inductor wire 50 is located between these portions of the inter-wire insulator layer 32. More specifically, the inductor wire 50 extends in an area defined by the inter-wire insulator layer 32 and located in the first positive direction X1 with respect to the first interlayer insulator layer 31.

As illustrated in FIG. 5, at least one of the outer surfaces of the first interlayer insulator layer 31 facing in a direction parallel to the first main surface 11A is defined as an end surface EF. “The surface facing in a direction parallel to the first main surface 11A” is a viewable surface when the first interlayer insulator layer 31 is viewed in a direction parallel to the first main surface 11A. Each outer insulator layer 32A can be roughly divided into a contact end portion BP located at the same position as the first interlayer insulator layer 31 in the first positive direction X1, and a body portion AP located in the first positive direction X1 with respect to the contact end portion BP. The contact end portion BP and the body portion AP are described in detail below.

As illustrated in FIG. 2, the inductor component 10 includes two columnar wires 40 and two outer electrodes 60. Each columnar wire 40 extends in a direction crossing the first main surface 11A. In the present embodiment, each columnar wire 40 extends in a direction orthogonal to the first main surface 11A. Each columnar wire 40 is located in the first positive direction X1 with respect to the inductor wire 50. Each columnar wire 40 is electrically connected to the inductor wire 50.

More specifically, a first columnar wire 41, which is one of the two columnar wires 40, includes a first via 41A and a first extended wire 41B. The material of the first columnar wire 41 is the same as the material of the inductor wire 50. The first via 41A is substantially cylindrical. As illustrated in FIG. 4, the first via 41A extends through the second interlayer insulator layer 33. Thus, the first via 41A is located at the same position as the second interlayer insulator layer 33 and the second interlayer magnetic layer 24 in the first positive direction X1. The surface of the first via 41A facing in the first negative direction X2 is connected to the inner pad portion 51PA of the inductor wire 50.

As illustrated in FIG. 3, the first extended wire 41B is substantially cylindrical. As illustrated in FIG. 2, the diameter of the first extended wire 41B is slightly greater than the diameter of the first via 41A. The surface of the first extended wire 41B facing in the first negative direction X2 is connected to the first via 41A. Thus, the first extended wire 41B is located at the same position as the third magnetic layer 25 in the first positive direction X1. The surface of the first extended wire 41B facing in the first positive direction X1 is exposed from the first main surface 11A.

As illustrated in FIG. 2, a second columnar wire 42, which is the other one of the two columnar wires 40, includes a second via 42A and a second extended wire 42B. The material of the second columnar wire 42 is the same as the material of the inductor wire 50. The second columnar wire 42 is located in the second negative direction Y2 with respect to the first columnar wire 41. The second via 42A is a substantially quadrangular prism. The second via 42A extends through the second interlayer insulator layer 33. Thus, the second via 42A is located at the same position as the second interlayer insulator layer 33 and the second interlayer magnetic layer 24 in the first positive direction X1. The surface of the second via 42A facing in the first negative direction X2 is connected to the outer pad portion 51PB of the inductor wire 50.

As illustrated in FIG. 3, the second extended wire 42B is a substantially quadrangular prism. As illustrated in FIG. 2, the dimension of each side of the second extended wire 42B is slightly greater than the dimension of the corresponding side of the second via 42A. The surface of the second extended wire 42B facing in the first negative direction X2 is connected to the second via 42A. Thus, the second extended wire 42B is located at the same position as the third magnetic layer 25 in the first positive direction X1. The surface of the second extended wire 42B facing in the first positive direction X1 is exposed from the first main surface 11A.

As illustrated in FIG. 1, each outer electrode 60 is exposed from the element 11. More specifically, each outer electrode 60 is located on the first main surface 11A of the element 11. Specifically, each outer electrode 60 covers a portion of the outer surface of the element 11.

As illustrated in FIG. 2, a first outer electrode 61, which is one of the two outer electrodes 60, is located on the first main surface 11A at a portion located in the second positive direction Y1 with respect to the geometric center of the first main surface 11A. The first outer electrode 61 is in contact with the surface of the first extended wire 41B facing in the first positive direction X1. A second outer electrode 62, which is the other one of the two outer electrodes 60, is located on the first main surface 11A at a portion located in the second negative direction Y2 with respect to the geometric center of the first main surface 11A. The second outer electrode 62 is in contact with the surface of the second extended wire 42B facing in the first positive direction X1.

The inductor component 10 includes a solder resist 70. The solder resist 70 covers a portion of the surface of the element 11 facing in the first positive direction X1, excluding the two outer electrodes 60. In other words, the first main surface 11A of the element 11 is covered with the outer electrode 60 and the solder resist 70 without being exposed. The solder resist 70 has higher insulating properties than the element 11.

### Inter-Wire Insulator Layer

As described above, each outer insulator layer 32A of the inter-wire insulator layer 32 can be roughly divided into a contact end portion BP located at the same position as the first interlayer insulator layer 31 in the first positive direction X1 and a body portion AP located in the first positive direction X1 with respect to the contact end portion BP. The body portion AP is located at the same position as the inductor wire 50 in the first positive direction X1.

As illustrated in FIG. 5, the contact end portion BP is in contact with one end surface EF of the first interlayer insulator layer 31. In the specific cross section, one of the outer surfaces of the contact end portion BP facing away from the first interlayer insulator layer 31 is a slope SF that is located closer to the first interlayer insulator layer 31 as it extends further in the first negative direction X2. Specifically, the contact end portion BP is substantially triangular in the specific cross section.

The body portion AP is in contact with the surface of the first interlayer insulator layer 31 facing in the first positive direction X1. Thus, the dimension of the body portion AP in a direction along the third axis Z at an end in the first negative direction X2 is greater than the dimension of the contact end portion BP in the direction along the third axis Z at a portion located in the first positive direction X1. More specifically, when the first interlayer insulator layer 31 is viewed in the first positive direction X1, a portion of the body portion AP protrudes beyond the contact end portion BP toward the inductor wire 50. The portion of the body portion AP protruding beyond the contact end portion BP is in contact with the surface of the first interlayer insulator layer 31 facing in the first positive direction X1. Thus, the outer insulator layer 32A is also in contact with the surface of the first interlayer insulator layer 31 facing in the first positive direction X1 in addition to the end surface EF of the first interlayer insulator layer 31.

In the specific cross section, the dimension of the body portion AP of the outer insulator layer 32A in a direction along the third axis Z is the same as the dimension of the inner insulator layer 32B in the direction along the third axis Z. More specifically, except for the contact end portion BP of the first interlayer insulator layer 31, the outer insulator layer 32A and the inner insulator layer 32B have substantially the same shape.

An interval V1 between the outer insulator layer 32A and the inner insulator layer 32B facing the outer insulator layer 32A is greater than an interval V2 between the inner insulator layers 32B facing each other. More specifically, the interval V1 between the outer insulator layer 32A and the inner insulator layer 32B in a direction parallel to the first main surface 11A is greater than the interval V2 between the inner insulator layers 32B in the direction parallel to the first main surface 11A. Thus, the wire width of the inductor wire 50 located between the outer insulator layer 32A and the inner insulator layer 32B is greater than the wire width of the inductor wire 50 located between the inner insulator layers 32B.

### Manufacturing Method

A method for manufacturing the inductor component 10 is described now.

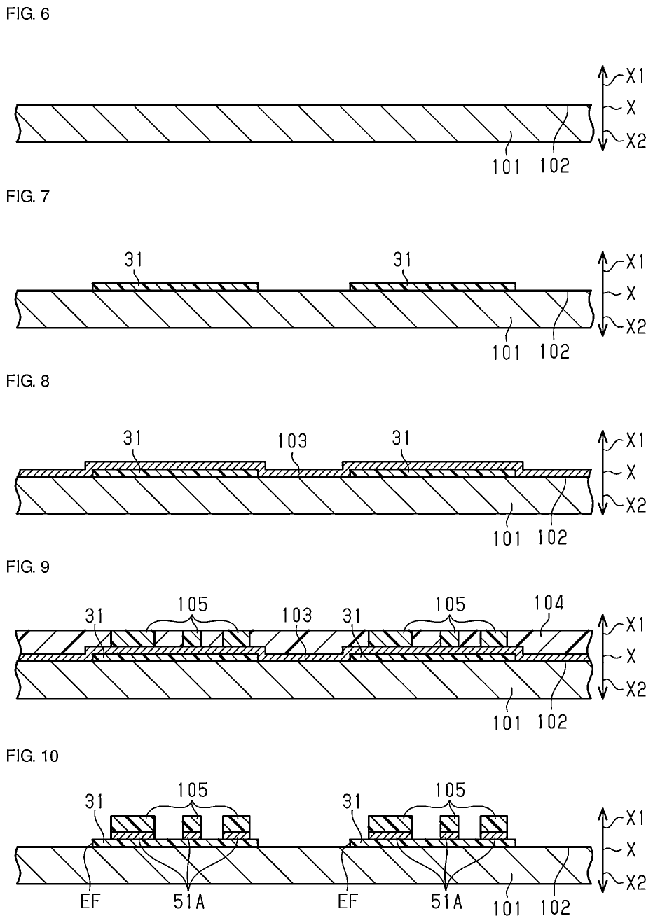

As illustrated in FIG. 6, first, a base preparation process is performed. More specifically, a planar base member 101 is prepared. The material of the base member 101 is ceramics. When viewed in the first negative direction X2, the base member 101 is quadrangular. The dimension of each side of the base member 101 is determined to receive multiple inductor components 10. A dummy insulator layer 102 is then applied to the entire upper surface of the base member 101. In FIG. 6, the dummy insulator layer 102 is illustrated with a bold line.

As illustrated in FIG. 7, a first-insulating-layer processing process to form the first interlayer insulator layer 31 is then performed. The first interlayer insulator layer 31 is formed on the surface of the base member 101 facing in the first positive direction X1. More specifically, the first interlayer insulator layer 31 undergoes patterning. The patterning is performed over a range slightly wider than a range in which the inductor wire 50 is disposed. More specifically, the first interlayer insulator layer 31 is formed by photolithography.

As illustrated in FIG. 8, a seed forming process to form the seed layer 51A is performed. More specifically, a copper seed portion 103 is formed by sputtering on the surfaces of the first interlayer insulator layer 31 and the dummy insulator layer 102 facing in the first positive direction X1.

As illustrated in FIG. 9, a photosensitive resist 104 is then laminated on the upper surface of the seed portion 103. Of the upper surface of the seed portion 103, only a range in which the seed layer 51A of the inductor wire 50 is to be formed is exposed to light. The portion of the resist 104 exposed to light is cured. This cured portion is formed as a cover portion 105. Thereafter, a portion of the resist 104 that is not cured, that is, a portion of the resist 104 other than the cover portion 105 is removed.

As illustrated in FIG. 10, the seed portion 103 is then etched. The seed portion 103 exposed from the cover portion 105 is then removed.

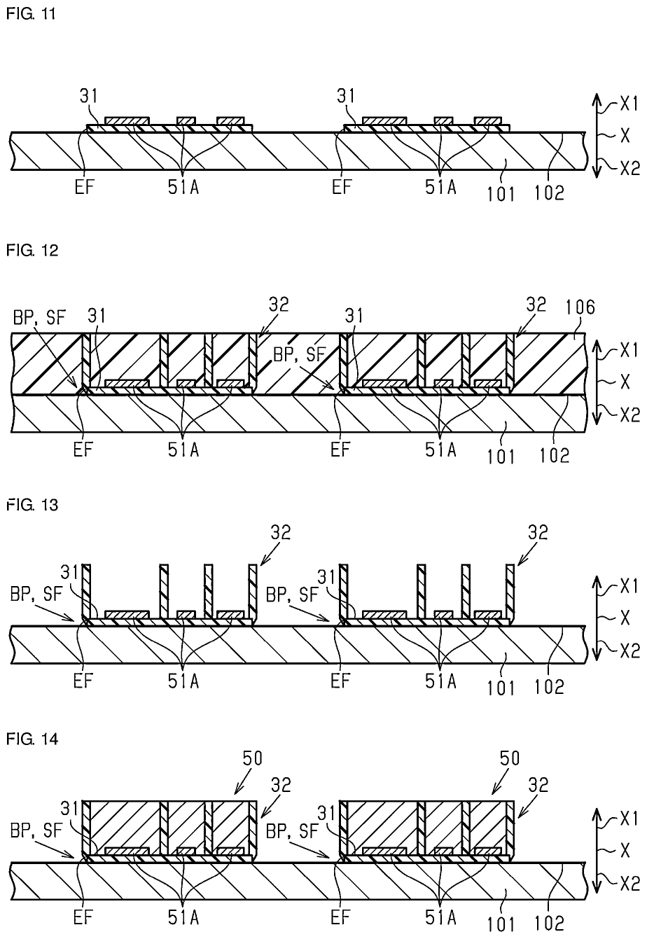

As illustrated in FIG. 11, the cover portion 105 undergoes wet etching using a chemical agent. The cover portion 105 is thus detached. Thus, the seed layer 51A is formed.

As illustrated in FIG. 12, a second-insulating-layer processing process to form the inter-wire insulator layer 32 is performed. More specifically, first, a photosensitive permanent resist 106 is laminated on the surfaces of the dummy insulator layer 102, the seed layer 51A, and the first interlayer insulator layer 31 facing in the first positive direction X1. Subsequently, ranges in which the inter-wire insulator layer 32 is to be formed, that is, portions located on both sides of the seed layer 51A are exposed to light. More specifically, a range of a portion of the surface of the first interlayer insulator layer 31 facing in the first positive direction X1 and a range of the first interlayer insulator layer 31 including a portion located in the first positive direction X1 with respect to the end surface EF are exposed to light. The range of the first interlayer insulator layer 31 including a portion located in the first positive direction X1 with respect to the end surface EF is exposed to a smaller amount of light than light to which the other portions are exposed. The amount of exposure light is thus managed to, as illustrated in FIG. 13, leave a portion of the permanent resist 106 located in the first negative direction X2 uncured in the range of the first interlayer insulator layer 31 including a portion located in the first positive direction X1 with respect to the end surface EF, and to form the slope SF of the contact end portion BP.

Subsequently, as illustrated in FIG. 13, the uncured portion of the permanent resist 106 is detached and removed by a chemical solution. Thus, the inter-wire insulator layer 32 is formed.

As illustrated in FIG. 14, a first-wire forming process to form the inductor wire 50 is then performed. More specifically, electrolytic copper plating is performed to allow copper to grow at a portion where the seed layer 51A is exposed on the surface of the first interlayer insulator layer 31 facing in the first positive direction X1. Thus, the inductor wire 50 is formed. In the process of forming the inductor wire 50, the seed layer 51A is located between the portions of inter-wire insulator layer 32, and thus, the copper plating grows along the inter-wire insulator layer 32. Thus, the inductor wire 50 has a substantially rectangular cross section. In the process of promoting growth of copper plating on the seed layer 51A, the surface of the inductor wire 50 facing in the first positive direction X1 may become a convex surface curving out in the first positive direction X1.

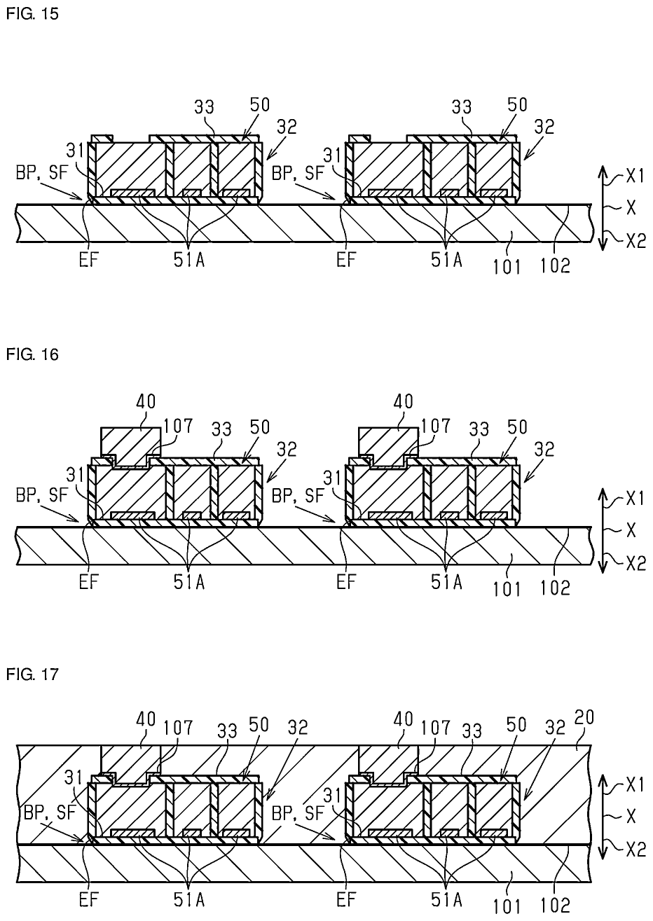

As illustrated in FIG. 15, a third-insulating-layer processing process to form the second interlayer insulator layer 33 is performed. The second interlayer insulator layer 33 is formed in a range of the surfaces of the inductor wire 50 and the inter-wire insulator layer 32 facing in the first positive direction X1, excluding portions where the first via 41A and the second via 42A are to be formed. Within this range, the second interlayer insulator layer 33 is formed by photolithography, that is the same as the method by which the first interlayer insulator layer 31 is formed. The dimension of the second interlayer insulator layer 33 in the direction along the first axis X is the same as the dimension of the first interlayer insulator layer 31 in the direction along the first axis X. When viewed in the first negative direction X2, the profile of the second interlayer insulator layer 33 matches the profile of the first interlayer insulator layer 31.

As illustrated in FIG. 16, a second-wire forming process to form the columnar wires 40 is then performed. the columnar wires 40 are formed in the ranges including the ranges where the inductor wire 50 is exposed from the second interlayer insulator layer 33. First, as in the above seed forming process, a columnar seed layer 107 is formed in the above range. The columnar seed layer 107 is not illustrated in FIGS. 2 to 5. The resist is exposed to light at a portion other than the above ranges by photolithography, which is the same method as in the first-insulating-layer processing process. The process the same as the first-wire forming process is performed to form the columnar wires 40 by copper plating. The resist is then removed. Thus, the first columnar wire 41 and the second columnar wire 42 are formed.

As illustrated in FIG. 17, a first magnetic-body forming process to form the magnetic layers 20 other than the first magnetic layer 21 is performed. First, a resin containing metal powder which is the material of the magnetic layers 20 is applied to the surface of the dummy insulator layer 102 facing in the first positive direction X1. At this time, the resin containing metal powder is applied to cover also the surface of each columnar wire 40 facing in the first positive direction X1. Thereafter, the resin containing metal powder is cured by pressing to form the first interlayer magnetic layer 22, the second magnetic layer 23, the second interlayer magnetic layer 24, and the third magnetic layer 25 on the surface of the dummy insulator layer 102 facing in the first positive direction X1.

Thereafter, a portion of the third magnetic layer 25 facing in the first positive direction X1 is shaved until the surface of each columnar wire 40 facing in the first positive direction X1 is exposed. In FIG. 17, the first interlayer magnetic layer 22, the second magnetic layer 23, the second interlayer magnetic layer 24, and the third magnetic layer 25 are illustrated as the magnetic layers 20 without being distinguished from one another.

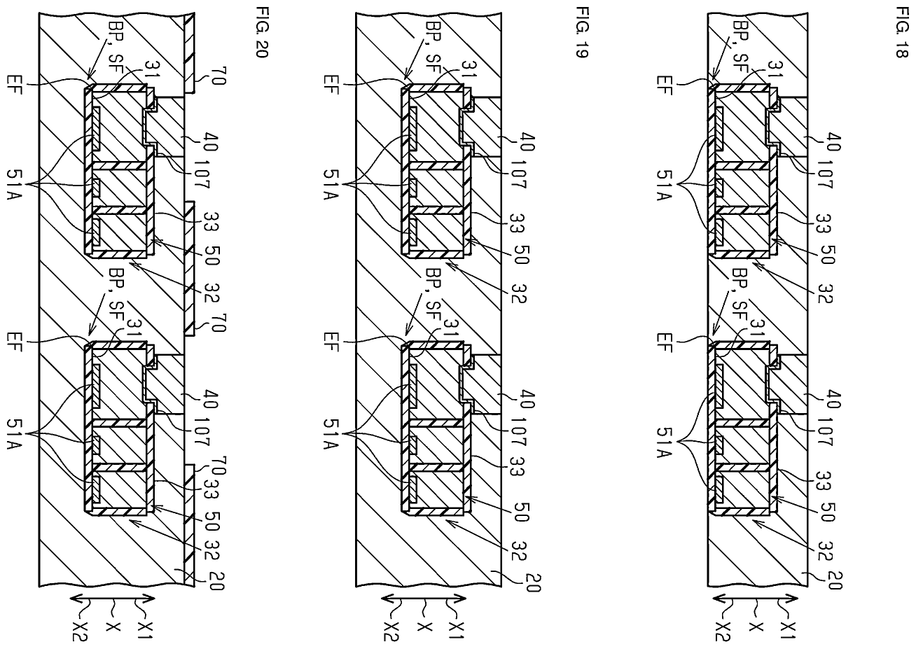

As illustrated in FIG. 18, a base-member cutting process is then performed. More specifically, the base member 101 and the dummy insulator layer 102 are entirely removed by cutting. After the base member 101 and the dummy insulator layer 102 are entirely cut, a portion of the first interlayer insulator layer 31 located in the first negative direction X2 may be removed, but the inductor wire 50 is not removed.

As illustrated in FIG. 19, a second-magnetic-body forming process to form the first magnetic layer 21 is performed. More specifically, first, a resin containing metal powder, which is the material of the first magnetic layer 21, is applied to the surfaces of the first interlayer insulator layer 31 and the first interlayer magnetic layer 22 facing in the first negative direction X2. Thereafter, the resin containing metal powder is cured by pressing. A portion of the resin located in the first negative direction X2 is then shaved. For example, a portion of the resin located in the first negative direction X2 is shaved to allow the inductor component 10 to have a desired dimension in the direction along the first axis X. Thus, the first magnetic layer 21 is formed on the surfaces of the first interlayer insulator layer 31 and the first interlayer magnetic layer 22 facing in the first negative direction X2. In FIG. 19, the first magnetic layer 21, the first interlayer magnetic layer 22, the second magnetic layer 23, the second interlayer magnetic layer 24, and the third magnetic layer 25 are illustrated as the magnetic layers 20 without being distinguished from one another.

As illustrated in FIG. 20, a main-surface processing process to form the solder resist 70 is then performed. More specifically, an insulator is patterned by photolithography on the surface of the third magnetic layer 25 facing in the first positive direction X1 and the surface of each columnar wire 40 facing in the first positive direction X1 at portions where no outer electrode 60 is formed. Thus, the solder resist 70 is formed.

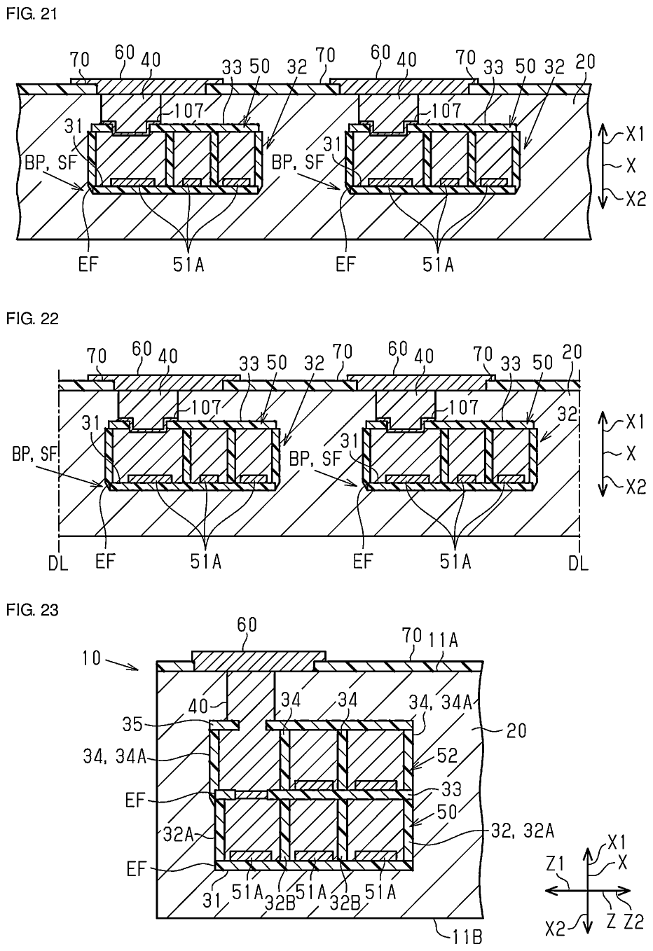

As illustrated in FIG. 21, an electrode processing process to form the outer electrodes 60 is then performed. The outer electrodes 60 are formed in the ranges not covered with the solder resist 70 on the surface of the third magnetic layer 25 facing in the first positive direction X1 and the surface of each columnar wire 40 facing in the first positive direction X1. These ranges undergo electroless plating with copper, nickel, and gold. Thus, the first outer electrode 61 and the second outer electrode 62 are formed. In FIG. 21, the copper, nickel, and gold layers are illustrated without being distinguished from one another. As illustrated in FIG. 21, a part of each outer electrode 60 may cover a part of the surface of the solder resist 70 facing in the first positive direction X1. As illustrated in FIG. 22, a process of dividing into pieces is then performed. More specifically, the workpiece is cut with a dicing machine along broken lines DL to be divided into pieces. Thus, the inductor component 10 can be obtained.

### Effect of Present Embodiment

(1) In the above embodiment, the inter-wire insulator layer 32 is in contact with the end surfaces EF of the first interlayer insulator layer 31. More specifically, when viewed in perspective in the first positive direction X1, at least a portion of the inter-wire insulator layer 32 protrudes outward beyond the surface of the first interlayer insulator layer 31 facing in the first positive direction X1. Thus, compared to a structure where the entirety of the inter-wire insulator layer 32 is located within the range of the surface of the first interlayer insulator layer 31 facing in the first positive direction X1, this structure can increase the area defined by the inter-wire insulator layer 32, that is, the area where the inductor wire 50 can be disposed.
(2) If the outer insulator layers 32A are in contact with the first interlayer insulator layer 31 only on one surface, the outer insulator layers 32A are more easily detached from the first interlayer insulator layer 31 when an external force in a direction parallel to the contact surface between the outer insulator layers 32A and the first interlayer insulator layer 31 is exerted on the outer insulator layers 32A. In contrast, in the embodiment, the outer insulator layers 32A are in contact with the surface of the first interlayer insulator layer 31 facing in the first positive direction X1 in addition to the end surfaces EF of the first interlayer insulator layer 31. More specifically, in the embodiment, each outer insulator layer 32A is in contact with the first interlayer insulator layer 31 on two surfaces. Thus, when the external force is exerted on the outer insulator layer 32A, the external force can be distributed between two surfaces that are in contact with the first interlayer insulator layer 31. The above structure can thus reduce detachment of the outer insulator layer 32A from the first interlayer insulator layer 31.
(3) In the above embodiment, in a specific cross section, the interval V1 between the outer insulator layer 32A and the inner insulator layer 32B in the direction parallel to the first main surface 11A is greater than the interval V2 between the inner insulator layers 32B in the direction parallel to the first main surface 11A. As described above, the outer insulator layer 32A protrudes outward beyond the surface of the first interlayer insulator layer 31 facing in the first positive direction X1. This structure can thus increase the interval V1 between the outer insulator layer 32A and the inner insulator layer 32B. Thus, the direct current resistance in the inductor wire 50 can be reduced.
(4) In the above embodiment, the columnar wires 40 are located in the first positive direction X1 with respect to the inductor wire 50. More specifically, in the above embodiment, the outer insulator layers 32A of the inter-wire insulator layer 32 are in contact with the end surfaces EF of the first interlayer insulator layer 31 and located further from the outer electrode 60. Thus, regardless of when by any chance the inductor wire 50 protrudes beyond a space between the outer insulator layer 32A and the first interlayer insulator layer 31, the extended inductor wire 50 is less likely to form a short circuit with the outer electrode 60.
(5) In the above embodiment, the inductor wire 50 includes the seed layer 51A that is in contact with the surface of the first interlayer insulator layer 31 facing in the first positive direction X1. More specifically, in the above embodiment, the outer insulator layers 32A of the inter-wire insulator layer 32 are in contact with the end surfaces EF of the first interlayer insulator layer 31 at positions near the seed layer 51A. Thus, regardless of when the position of the seed layer 51A is shifted from a designed position during the manufacturing process, the inductor wire 50 is less likely to protrude beyond a space between the outer insulator layer 32A and the first interlayer insulator layer 31.
(6) In the above embodiment, one of the outer surfaces of the contact end portion BP facing away from the first interlayer insulator layer 31 is a slope SF that is located closer to the first interlayer insulator layer 31 as it extends further in the first negative direction X2. Compared to a structure where the dimension of the outer insulator layer 32A in the direction along the third axis Z is uniform without including the slope SF, this structure can enlarge the volume of the first interlayer magnetic layer 22.

### MODIFICATION EXAMPLES

The above embodiment and any of modification examples described below may be combined with each other to be embodied within a technically non-contradictory range.

In the above embodiment, the inductor component 10 may eliminate the outer electrodes 60. In this case, portions of the columnar wires 40 exposed from the first main surface 11A may be used as electrodes.

In the above embodiment, each columnar wire 40 may extend in a direction crossing the first main surface 11A instead of the direction orthogonal to the first main surface 11A.

In the above embodiment, the shape of each columnar wire 40 when viewed in perspective in the direction orthogonal to the first main surface 11A is not limited to the example in the embodiment. For example, all the columnar wires 40 may have the same shape when viewed in perspective in the direction orthogonal to the first main surface 11A.

In the above embodiment, the material of the insulating layers 30 is not limited to the example of the embodiment. For example, the material of the insulating layer 30 may be an epoxy resin.

In the above embodiment, the number of turns of the inductor wire 50 and the shape of the inductor wire 50 are not limited to the examples of the embodiment. For example, the inductor wire 50 may be linear with zero turns.

In the above embodiment, a portion of the inductor wire 50 may be in contact with the magnetic layers 20 without being covered with the insulating layers 30. For example, the embodiment may eliminate the second interlayer insulator layer 33. “The case where the surface of the inter-wire insulator layer 32 facing in the direction parallel to the first main surface 11A is in contact with the element 11” indicates the case where higher than or equal to 90% of the surface of the inter-wire insulator layer 32 facing in the direction parallel to the first main surface 11A is in contact with the element 11. In a structure not including the second interlayer insulator layer 33, a portion of the surface of each inner insulator layer 32B facing in a direction parallel to the first main surface 11A may be in contact with the element 11 due to, for example, manufacturing errors. Also in such a case, the portion does not correspond to the outer insulator layer 32A as long as the rate at which the surface of the inter-wire insulator layer 32 facing in a direction parallel to the first main surface 11A is in contact with the element 11 is smaller than 90%.

In the above embodiment, the inductor component 10 may include multiple inductor wires 50. For example, the inductor wire 50 in the embodiment is defined as a first inductor wire 50, the inter-wire insulator layer 32 is defined as a first inter-wire insulator layer 32, and the outer insulator layers 32A are defined as first outer insulator layers 32A. In the example illustrated in FIG. 23, all the first outer insulator layers 32A of the first inter-wire insulator layer 32 extend from the surface of the first interlayer insulator layer 31 facing in the first positive direction X1. In the example illustrated in FIG. 23, the inductor component 10 further includes a second inductor wire 52, a second inter-wire insulator layer 34, and a third interlayer insulator layer 35. In the example illustrated in FIG. 23, the second inter-wire insulator layer 34 extends from the second interlayer insulator layer 33 in the first positive direction X1. The second inductor wire 52 extends in an area defined by the second inter-wire insulator layer 34, and is located in the first positive direction X1 with respect to the second interlayer insulator layer 33. The third interlayer insulator layer 35 extends over the surfaces of the second inductor wire 52 and the second inter-wire insulator layer 34 facing in the first positive direction X1. In the example illustrated in FIG. 23, the columnar wire 40 is connected to the second inductor wire 52.

As in the first inter-wire insulator layer 32, in the example illustrated in FIG. 23, in a specific cross section, seven portions of the second inter-wire insulator layer 34 are discontinuously arranged in a direction along the first main surface 11A. FIG. 23 illustrates four of the seven portions of the second inter-wire insulator layer 34.

One of the outer surfaces of the second interlayer insulator layer 33 facing in a direction parallel to the first main surface 11A is defined as the end surface EF, and, in a specific cross section, one portion of the second inter-wire insulator layer 34 with a surface facing in a direction parallel to the first main surface 11A being in contact with the element 11 is defined as a second outer insulator layer 34A. The second outer insulator layer 34A located furthest in the third positive direction Z1 in a specific cross section is in contact with the end surface EF of the second interlayer insulator layer 33 and the surface of the first outer insulator layer 32A facing the element 11. Compared to the structure where the second outer insulator layer 34A is in contact with only the second interlayer insulator layer 33, this structure can increase the contact surface of the second outer insulator layer 34A. More specifically, the second outer insulator layer 34A improves its contact properties.

In the example illustrated in FIG. 23, each first outer insulator layer 32A of the first inter-wire insulator layer 32 may also be in contact with the corresponding end surface EF of the first interlayer insulator layer 31. In the example illustrated in FIG. 23, the second outer insulator layer 34A of the second inter-wire insulator layer 34 may be in no contact with the end surface EF of the second interlayer insulator layer 33 while each first outer insulator layer 32A of the first inter-wire insulator layer 32 is in contact with the corresponding end surface EF of the first interlayer insulator layer 31.

In the above embodiment, the multiple outer insulator layers 32A may include at least one outer insulator layer 32A that is in contact with the end surface EF of the first interlayer insulator layer 31.

In the above embodiment, each outer insulator layer 32A may be in contact with the corresponding end surface EF of the first interlayer insulator layer 31 or the second interlayer insulator layer 33. More specifically, each outer insulator layer 32A may be in no contact with the surface of the first interlayer insulator layer 31 facing in the first positive direction X1.

In the above embodiment, the columnar wires 40 may be located in the first negative direction X2 with respect to the inductor wire 50. Similarly, the outer electrodes 60 may be exposed from the second main surface 11B. In other words, the mount surface of the inductor component 10 may be the second main surface 11B.

In the above embodiment, the interval V1 between the outer insulator layer 32A and the inner insulator layer 32B in a specific cross section may be the same as or smaller than the interval V2 between the inner insulator layers 32B.

In the above embodiment, one of the outer surfaces of the contact end portion BP facing away from the first interlayer insulator layer 31 may be other than the slope SF. For example, in a specific cross section, the contact end portion BP may have a uniform dimension in the direction along the third axis Z.

In the above embodiment, the material of the base member 101 is not limited to the example in the above embodiment. For example, the material of the base member 101 may be a glass epoxy resin or glass.

In the wire forming process according to the above embodiment, a dummy wire to be connected to the inductor wire 50 may be formed. For example, a dummy wire is usable as a power supply wire to form copper plating.

### Appendix

Technological ideas derived from the above embodiment and modification examples are described below.
[1] An inductor component, comprising an element having a main surface; an interlayer insulator layer extending in the element to be parallel to the main surface; an inter-wire insulator layer extending from the interlayer insulator layer in a first positive direction orthogonal to the main surface; and an inductor wire extending in an area defined by the inter-wire insulator layer, and located in the first positive direction with respect to the interlayer insulator layer. In a specific cross section taken orthogonal to a center line of the inductor wire, a plurality of portions of the inter-wire insulator layer are discontinuously arranged in a direction along the main surface. Also, when one of outer surfaces of the interlayer insulator layer facing in a direction parallel to the main surface is defined as an end surface, and one of the plurality portions of the inter-wire insulator layer with a surface facing in the direction parallel to the main surface being in contact with the element is defined as an outer insulator layer, the outer insulator layer is in contact with the end surface of the interlayer insulator layer.
[2] The inductor component according to [1], wherein the outer insulator layer is in contact with a surface of the interlayer insulator layer facing in the first positive direction in addition to the end surface of the interlayer insulator layer.
[3] The inductor component according to [1] or [2], wherein, when one of the plurality portions of the inter-wire insulator layer with a surface facing in the direction parallel to the main surface being in no contact with the element is defined as an inner insulator layer, an interval between the outer insulator layer and the inner insulator layer in the direction parallel to the main surface in the specific cross section is greater than an interval between two portions of the inner insulator layer in the direction parallel to the main surface.
[4] The inductor component according to any one of [1] to [3], comprising a columnar wire electrically connected to the inductor wire, and extending in a direction crossing the main surface. the columnar wire is located in the first positive direction with respect to the inductor wire.
[5] The inductor component according to any one of [1] to [4], wherein the inductor wire includes a seed layer that is in contact with a surface of the interlayer insulator layer facing in the first positive direction.
[6] The inductor component according to any one of [1] to [5], wherein, when a direction opposite to the first positive direction is defined as a first negative direction, and when a portion of the outer insulator layer located at the same position as the interlayer insulator layer in the first positive direction is defined as a contact end portion, one of outer surfaces of the contact end portion facing away from the interlayer insulator layer is a slope that is located closer to the interlayer insulator layer as the outer surface extends further in the first negative direction.
[7] The inductor component according to any one of [1] to [6], wherein, when the inductor wire is defined as a first inductor wire, the interlayer insulator layer is defined as a first interlayer insulator layer, the inter-wire insulator layer is defined as a first inter-wire insulator layer, and the outer insulator layer is defined as a first outer insulator layer, the inductor component comprises a second interlayer insulator layer extending over surfaces of the first inductor wire and the first inter-wire insulator layer facing in the first positive direction; a second inter-wire insulator layer extending from the second interlayer insulator layer in the first positive direction; and a second inductor wire extending in an area defined by the second inter-wire insulator layer, and located in the first positive direction with respect to the second interlayer insulator layer. In the specific cross section, a plurality of portions of the second inter-wire insulator layer are discontinuously arranged in the direction along the main surface. Also, when one of outer surfaces of the second interlayer insulator layer facing in the direction parallel to the main surface is defined as an end surface, and a portion of the plurality portions of the second inter-wire insulator layer with a surface facing in the direction parallel to the main surface being in contact with the element is defined as a second outer insulator layer, the second outer insulator layer is in contact with the end surface of the second interlayer insulator layer and a surface of the first outer insulator layer facing the element.

What is claimed is:

1. An inductor component, comprising:
an element having a main surface;
an interlayer insulator layer extending in the element to be parallel to the main surface;
an inter-wire insulator layer extending from the interlayer insulator layer in a first positive direction orthogonal to the main surface; and
an inductor wire extending in an area defined by the inter-wire insulator layer, and located in the first positive direction with respect to the interlayer insulator layer,
wherein
in a specific cross section taken orthogonal to a center line of the inductor wire, a plurality of portions of the inter-wire insulator layer are discontinuously arranged in a direction along the main surface, and
when one of outer surfaces of the interlayer insulator layer facing in a direction parallel to the main surface is defined as an end surface, and one of the plurality portions of the inter-wire insulator layer with a surface facing in the direction parallel to the main surface being in contact with the element is defined as an outer insulator layer, the outer insulator layer is in contact with the end surface of the interlayer insulator layer.

2. The inductor component according to claim 1, wherein
the outer insulator layer is in contact with a surface of the interlayer insulator layer facing in the first positive direction in addition to the end surface of the interlayer insulator layer.

3. The inductor component according to claim 1, wherein
when one of the plurality portions of the inter-wire insulator layer with a surface facing in the direction parallel to the main surface being in no contact with the element is defined as an inner insulator layer, an interval between the outer insulator layer and the inner insulator layer in the direction parallel to the main surface in the specific cross section is greater than an interval between two portions of the inner insulator layer in the direction parallel to the main surface.

4. The inductor component according to claim 1, further comprising:
a columnar wire electrically connected to the inductor wire, and extending in a direction crossing the main surface,
wherein the columnar wire is in the first positive direction with respect to the inductor wire.

5. The inductor component according to claim 1, wherein
the inductor wire includes a seed layer that is in contact with a surface of the interlayer insulator layer facing in the first positive direction.

6. The inductor component according to claim 1, wherein
when a direction opposite to the first positive direction is defined as a first negative direction, and when a portion of the outer insulator layer located at a same position as the interlayer insulator layer in the first positive direction is defined as a contact end portion, one of outer surfaces of the contact end portion facing away from the interlayer insulator layer is a slope that is closer to the interlayer insulator layer as the outer surface extends further in the first negative direction.

7. The inductor component according to claim 1, wherein
when the inductor wire is defined as a first inductor wire, the interlayer insulator layer is defined as a first interlayer insulator layer, the inter-wire insulator layer is defined as a first inter-wire insulator layer, and the outer insulator layer is defined as a first outer insulator layer, the inductor component comprises:
a second interlayer insulator layer extending over surfaces of the first inductor wire and the first inter-wire insulator layer facing in the first positive direction;
a second inter-wire insulator layer extending from the second interlayer insulator layer in the first positive direction; and
a second inductor wire extending in an area defined by the second inter-wire insulator layer, and located in the first positive direction with respect to the second interlayer insulator layer,
wherein
in the specific cross section, a plurality of portions of the second inter-wire insulator layer are discontinuously arranged in the direction along the main surface, and
when one of outer surfaces of the second interlayer insulator layer facing in the direction parallel to the main surface is defined as an end surface, and a portion of the plurality portions of the second inter-wire insulator layer with a surface facing in the direction parallel to the main surface being in contact with the element is defined as a second outer insulator layer, the second outer insulator layer is in contact with the end surface of the second interlayer insulator layer and a surface of the first outer insulator layer facing the element.
